(19) United States
(12) Patent Application Publication
(10) Pub. No.: US 2009/0313845 A1
(43) Pub. Date: Dec. 24, 2009

(54) Portable air blowing device

(76) Inventors: Francis H. Koh, Bethesda, MD (US); Franklin C. Koh, Potomac, MD (US)

Correspondence Address: Francis H. Koh;Suite 200, 4936 Fairmont Ave., Bethesda, MD, 20814, US

(21) Appl. No.: 12/456,785

(22) Filed: Jun. 23, 2009

Related U.S. Application Data
(60) Provisional application No. 61/132,850, filed on Jun. 23, 2008.

(51) Int. Cl. F26B 19/00

(52) U.S. Cl. 34/90

(57) ABSTRACT

A portable air-blowing device comprising a collapsible bulb structure that draws in air through a filter that is removably connected to the bulb and, upon manipulation by squeezing the bulb, expels the filtered air inside the bulb out through a nozzle that can be selectively directed upon a surface or object that the user desires to be cleared of dust. Inlet and outlet valves are part of the bulb structure, regulating the flow of air such that air flows in only one direction, in through the inlet and filter, and out through the outlet and nozzle.

### FIELD OF THE INVENTION

The present invention relates generally to manual air-blowing devices, specifically to a portable self-contained air-blowing device comprising a bulb that filters air that is drawn into the bulb as it expands, and allows a person to expel the filtered air out through a nozzle by squeezing the bulb.

### BACKGROUND OF THE INVENTION

Various types of air-expelling squeeze bulbs exist, such as bulbs that serve as health and personal hygiene devices for extracting liquids from ears and noses, to bulbs used to dispense dust by blowing out air. Bulbs are typically structured so that the bulb automatically expands after it is squeezed. There are single-opening bulbs, where a single opening draws in air and then that air is expelled through the same opening when the bulb is squeezed. Two-opening bulbs, on the other hand, typically function by drawing in air through one opening and expelling air out through the other, with air flow being regulated by having a one way valve inlet that allows air to enter through the inlet when the bulb expands, while preventing air from exiting the bulb inlet when the bulb is squeezed. These two openings are typically located on opposite sides of the bulb. Bulb blowers such as the foregoing can be used for general removal of fine dust particles from electronics, watches, jewelry, model making or other repair work, or other scientific and medical purposes. Examples of air bulbs and related structures are set forth in U.S. Pat. No. 6,698,421 to Attolini, U.S. Pat. No. 6,634,393 to Porter Et Al., and U.S. Pat. No. 6,725,568 to Gronka. The foregoing patents are herein incorporated by reference in their entirety.

There is a need, however, for a portable air-blowing device that filters air,for dust as the air is drawn into the device, and then expels the filtered air through the outlet opening. Such a device would be particularly useful when handling dust sensitive devices, such as electronics, or precision devices, such as watches.

### SUMMARY OF THE INVENTION

Electronic devices and precision equipment are prone to collect dust particles that may lead to the malfunction of the electronic device or the precision equipment. These devices and equipment routinely need to be cleared of dust to maintain proper operation.

In order to avoid blowing more dust onto such devices, the present invention draws air into a bulb through a filter that removes dust particles, and expels the dust-free air through another opening of the bulb to expel the dust off the object needing to be cleared of dust. Optical equipment and electronic image sensors typically need to be cleared of dust. Dust can interfere with electronic sensors, such as CMOS or CCD sensors of digital cameras, as well as interfere with the transmission of images through lenses. Air-filled cans are available, but do not last, and often times emit liquid due to condensation.

The present invention is a self-contained portable apparatus that avoids blowing dust-laden air onto dust-sensitive objects by purifying the air through a filter as the air is drawn inside the interior chamber of the bulb. This filtered dust-free air inside the chamber of the bulb can then be expelled forcefully upon a desired area that needs to be cleared of dust particles. The bulb can be made of any synthetic or natural material that is flexible and air tight, thus appropriate for making the bulb structure that self-expands after the bulb is squeezed. Nozzles and inlets can be made of any appropriate material, such as rubber or plastic. Inlets and outlet valves can be integrated within the nozzle tip or with the filter cartridge. These inlet and outlet valves are conventionally known as check valves and regulate flow in one direction. The filter can be any appropriate dust-removing filter, such as a HEPA filter, or any other appropriate filter that allows quick intake of air inside the bulb chamber with low resistance. Low profile HEPA filters with a pleated configuration that maximizes surface area through which air flows is an example of such a filter. A pleated filter arrangement, or similar configuration that maximizes surface area through which air passing through the filter, would greatly facilitate the volume of air flow which would lead to quicker bounce (expansion) of the bulb upon release after squeezing the bulb, or in the instance where the filter is placed at the front end of the bulb where the air is expelled, a low profile filter, such as a HEPA pleated filter or similar, would still provide low resistance and rapid flow. It is also contemplated within this invention that the HEPA filter comprises an electrostatic HEPA filter that discharges or neutralizes electrostatic charges of air and particulates drawn through the filter. HEPA filters are known to remove air particulates and humidity.

Another way to handle electrostatic charge would be to attach an electrostatic charge dissipating ring, such as a magnetic ring, at the front end or the back end of the bulb. This ring can be integrated with the nozzle such that air passes in contact with the surface of the ring. Another way would be to have some portion or all of the nozzle made of metal, such as stainless steel, or another composition that discharges electrostatic charge.

It is also contemplated within the purview of the invention that the bulb can be outfitted with other organic vapor filters, such as a charcoal activated filter. The filter can be placed in any position in the path of the air flow so that the final air expelled at the nozzle tip is filtered air. It is also within contemplation that the filter is connected to a bulb via a hose or tubing.

It is therefore an object of the invention to provide a portable dust-blowing apparatus that is effective for clearing dust off objects with purified dust-free air.

It is a further object of the invention to provide a portable dust-blowing apparatus that operates with a quick bounce while still providing purified air.

It is a further object of the invention to provide a portable dust-blowing apparatus that eliminates electrostatic charge of particles and air that passes through the device of the invention without the use of a power source.

It is a further object of the invention to provide a portable particulate-clearing apparatus that allows the user to manipulate the apparatus to select areas of the object needing to be cleared of dust.

It is a further object of the invention to provide a portable particulate clearing apparatus that is simple to manufacture, and is capable of being stored and transported easily, easily disassembled and easily assembled with replaceable and interchangeable components.

These and other objects of the present invention will become readily apparent upon further review of the following specification and drawings.

### BRIEF DESCRIPTION OF THE INVENTION

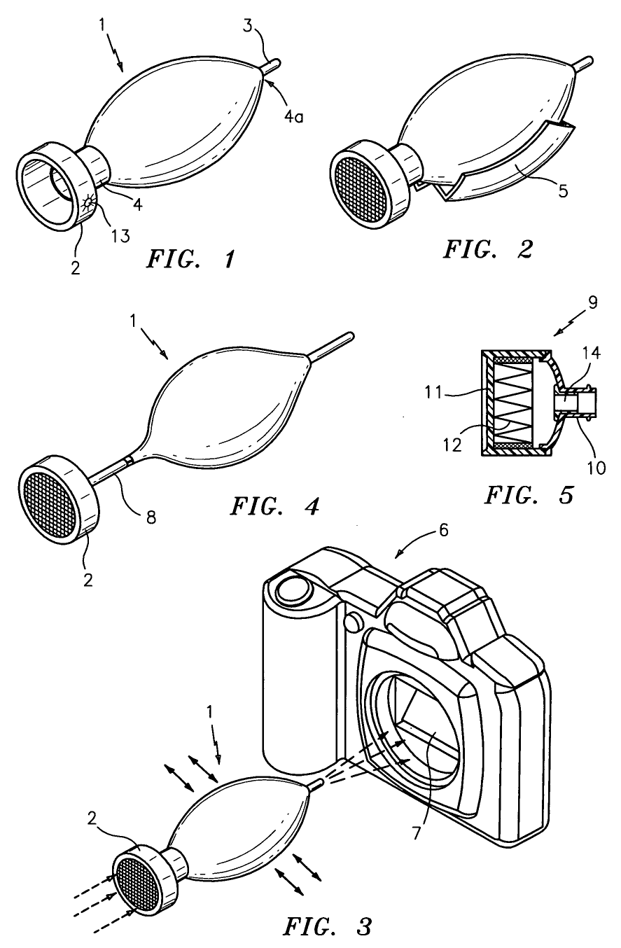

FIG. 1 shows a perspective view of the device.

FIG. 2 shows a perspective view of an embodiment of the device including fins.

FIG. 3. shows a demonstrative illustration of the device being used to blow dust particles off a camera's image sensor.

FIG. 4 shows a perspective view of another preferred embodiment of the device where the air filter is connected to the blower by way of a hose.

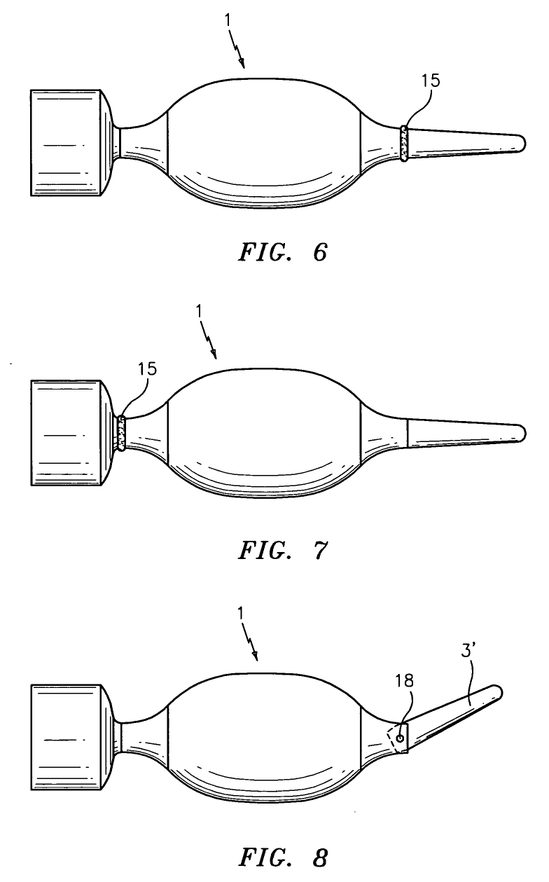

FIG. 5 shows a cross-sectional view of a HEPA filter cartridge with an integrated one-way valve.

FIG. 6 shows the filtered blower device with an electrostatic discharging ring positioned at the front end of the bulb.

FIG. 7 shows the filtered blowing device where the ring is positioned at the back end of the bulb.

FIG. 8 shows the filtered blower device with a selectively movable nozzle.

### DETAILED DESCRIPTION OF THE INVENTION

FIG. 1 shows a perspective drawing of the device comprising a collapsible bulb 1 with an air-filling chamber inside. When the bulb 1 is released after being compressed, re-expansion of the bulb causes air to be drawn in through a filter 2 that is removably connected to the rear end of the bulb 1 and optionally includes an indicator light 13, discussed in more detail below. The air flows into the chamber through the filter and through a one-way inlet valve 4 that prevents air from moving out through the filter 2 when the bulb 1 is compressed. When the bulb is squeezed, the air inside the bulb chamber is expelled through the outlet valve 4a and out through the nozzle 3 connected to the front end of the bulb. The outlet valve 4a is also a one-way valve, and this valve prevents air from being drawn into the chamber through the nozzle opening when the bulb is expanding and taking in air through the inlet. One-way valves are crucial to keeping unwanted dirty air from being drawn into the chamber and ensuring unidirectional air flow through the portable air-filtering blower device. Locating the filter 2 at the point where air is drawn in, rather than where it is blown out provides several benefits. One benefit is that it ensures that there is never a risk of blowing dirty air out of the blower because the air inside the chamber has always been filtered before it gets there, so that it is clean and free of particulate matter. Another major benefit is that when the bulb is compressed, the resistance to the air flow moving out through the nozzle is minimized because the air does not need to be forced through the filter on its way out through the nozzle. The resistance to the air flow that would be created by having the filter located at the outlet of the chamber rather than at the inlet would reduce the force of the air as it exits the nozzle, thereby reducing the effectiveness of the device in being able to blow the dust off the target site being cleaned.

FIG. 2 shows a perspective drawing of another embodiment of the invention featuring protruding fins 5 extending from the bulb to act as stabilizing structures and prevent the device from rolling when placed on a flat service.

FIG. 3. shows a demonstrative illustration of the device being used to clear dust off an image sensor 7 of a digital camera 6. As the bulb 1 expands, it draws in air through the filter 2 and fills the chamber. Squeezing the bulb 1, expels out the air through the nozzle opening which can be selectively directed upon the image sensor 7, thereby blowing dust off the image sensor with filtered air.

FIG. 4. shows a perspective drawing of yet another preferred embodiment of the invention where the filter 2 is connected to a hose 8 which is connected to the bulb 1. Proper fittings, connectors and adaptors may be necessary to connect the bulb to the hose and filter in the embodiment described in FIG. 4 or in any of the other described embodiments.

FIG. 5. Shows a drawing of a filter cartridge 9 that incorporates a one-way valve 14 right into the cartridge. The filter cartridge 9 has a connector tip 10 that connects to the bulb 1. Air flows through the back grid 11 and passes through the pleated HEPA filter 12 and through the one-way valve 14. While this embodiment shows the filter and the one-way valve as being incorporated into a single cartridge, it is within the scope of the invention that the filter and the one-way valve could be separate elements connected together using whatever fittings or connectors are necessary to ensure that air is allowed to pass through the filter in only one direction.

To keep the blower device working properly, the filter must be replaced periodically. One way that the user can recognize when it is time to change the filter is when the “bounce” time of the bulb increases. The bounce is defined as the time it takes for the bulb to refill with air after having been squeezed and released. If the filter becomes clogged, it will be more difficult for air to flow through the filter, and will therefore take more time for the bulb to expand, making for a slow bounce. Additionally, the filter can be provided with an indicator to let the user know when it is time to place the filter. The indicator can take any of a variety of forms. For example, the filter cartridge might include a light 13 that illuminates to alert the user that the filter must be replaced. Alternatively, a color indicator can be provided on the exterior of the filter cartridge, where the color of the indicator can change to indicate the amount of useful life remaining on the filter.

FIG. 6. Shows another embodiment of the invention where a charge dissipating ring 15 is positioned at the front end of the bulb 1. This ring 15 serves to remove electrical charge from the air passing through it so that the air being expelled by the blower is electrostatically neutral.

FIG. 7. Shows another embodiment of the invention where a charge dissipating ring 15 is positioned at the back end of the bulb 1.

FIG. 8. Shows another embodiment of the blower device where nozzle 3′ is selectively movable. Nozzle 3′ is connected via a pivot pin 18 to bulb 1, enabling the nozzle to be selectively directionally pointed. This mode of making the nozzle selectively movable is merely exemplary. It is considered within the scope of the invention to provide any other type of movable connection between the nozzle and the bulb, such as a hinge or a ball joint. Alternatively, the nozzle itself could be movable, such as in the form of a gooseneck.

The present invention is not limited to the embodiments described above, but encompasses any and all variations within the scope of the following claims.

What is claimed is:

1. A portable air-blowing device enabling the selective release of filtered air, the portable air-blowing device comprising:
a squeezable bulb having a hollow interior chamber with an inlet opening to draw air into the bulb and an outlet opening to expel air out from the bulb,
a filter removably connected to the bulb in the path of the air flow,
an inlet valve that provides for one-way flow of air into the bulb as the bulb is expanding but prevents air from exiting out of the inlet opening when the bulb is squeezed,
an outlet valve that allows air to be expelled out through the outlet opening as the bulb is squeezed, but prevents air from entering through the exit opening when the bulb is expanding.

2. The portable air-blowing device of claim 1, further comprising a nozzle connected to said outlet of said bulb.

3. The portable air-blowing device of claim 1, wherein said filter is located at the inlet opening of said bulb, such that all air entering said interior chamber of said bulb has been filtered before it enters.

4. The portable air-blowing device of claim 1, further comprising a stabilizing structure on the bulb to prevent the device from rolling while on flat surfaces.

5. The portable air-blowing device of claim 2, wherein said nozzle comprises a movable nozzle whose tip can be selectively oriented to adjust the angle at which filtered air is expelled relative to a longitudinal axis of said bulb.

6. The portable air-blowing device of claim 2, wherein said nozzle is detachable from said bulb.

7. The portable air-blowing device of claim 1, further comprising an indicator for indicating the status of the filter.

8. The portable air-blowing device of claim 1, wherein said filter is a HEPA filter.

9. The portable air-blowing device of claim 8, wherein said HEPA filter comprises an electrostatic HEPA filter that discharges or neutralizes electrostatic charges of air drawn through it.

10. The portable air-blowing device of claim 1, wherein said filter is an organic vapor filter.

11. The portable air-blowing device of claim 1, wherein said inlet valve is integrated with said filter.

12. The portable air-blowing device of claim 2, wherein said outlet valve is integrated with said nozzle.

13. The portable air-blowing device of claim 1, further comprising a charge-dissipating ring.
